(19) United States
(12) Patent Application Publication
(10) Pub. No.: US 2021/0219540 A1
(43) Pub. Date: Jul. 22, 2021

(54) TREE STAND APPARATUS AND METHOD

(71) Applicants: Mark Allen Schmidt, Essexville, MI (US); Nicholas Alan Hribek, Alger, MI (US)

(72) Inventors: Mark Allen Schmidt, Essexville, MI (US); Nicholas Alan Hribek, Alger, MI (US)

(73) Assignee: MH SYNDICATE LLC, Alger, MI (US)

(21) Appl. No.: 17/152,048

(22) Filed: Jan. 19, 2021

Related U.S. Application Data
(60) Provisional application No. 62/962,344, filed on Jan. 17, 2020.

(51) Int. Cl. A01M 31/02; A45F 3/26

(52) U.S. Cl. CPC A01M 31/02; A45F 3/26

(57) ABSTRACT

A tree stand apparatus includes a rail, a plurality of steps, a plurality of cleats for engagement with a tree, and a platform that is pivotable about an axis relative to the rail between an extended position and a retracted position. The axis is at approximately the midpoint of the length of the rail.

### CROSS REFERENCE TO RELATED APPLICATION

This application claims the benefit of U.S. provisional patent application No. 62/962,344, filed Jan. 17, 2020, and which is hereby incorporated by reference in its entirety.

### TECHNICAL FIELD

This disclosure relates to tree stands for use in hunting.

### BACKGROUND

Tree stands are often used by hunters and observers of wildlife. A tree stand often includes a seat, a foot platform, and a frame that is attached to the tree such as by chains or straps. Some prior art tree stands include a ladder attached to the frame to enable a hunter to access the stand from the ground.

### SUMMARY

According to one aspect of the disclosure, a tree stand apparatus includes a rail, a plurality of steps mounted to the rail and extending perpendicular to the rail, a plurality of cleats mounted to the rail and configured to engage a tree, and a platform being pivotably mounted with respect to the rail and selectively rotatable about an axis between a stowed position in which the platform is substantially parallel with the rail, and an extended position in which the platform is substantially perpendicular to the rail. The rail is characterized by a length and a midpoint along the length. The axis is a distance from the midpoint. The distance is less than or equal to 25% of the length.

The tree stand provided is lightweight and can be made compact for easy carrying by mobile hunters. The tree stand system provided herein is versatile and is useful in almost every hunting situation, including saddle hunting, traditional tree-stand hunting, and mobile hunting. The tree stand system facilitates the ability to locate and shoot game in all directions (360 degrees) and can place the tree between the hunter and game. Corresponding methods of using the tree stand system and packing the tree stand system are also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, side view of a tree stand system having first, second, and third ladder assemblies attached to a tree;

FIG. 2 is a schematic, front view of the first ladder assembly attached to the tree with step members in retracted positions;

FIG. 3 is a schematic, front view of the first ladder assembly attached to the tree with the step members in extended positions;

FIG. 4 is a schematic, side view of the first ladder assembly attached to the tree;

FIG. 5 is a schematic, front view of the third ladder assembly mounted to the tree with a platform in a stowed position;

FIG. 6 is a schematic, side view of the third ladder assembly mounted to the tree with the platform in an extended position;

FIG. 7 is a schematic, side view of the third ladder assembly with a seat assembly operative attached;

FIG. 8 is a schematic, side view of the tree stand assembly with a hunter standing on the platform;

FIG. 9 is a schematic, side view of the tree stand system with a hunter sitting on the seat assembly and facing the tree;

FIG. 10 is a schematic, side view of the tree stand system with a hunter sitting on the seat assembly, facing the tree, and supporting his or her feet on the platform;

FIG. 11 is a schematic, side view of the tree stand assembly with a hunter sitting on the seat assembly, facing away from tree, and supporting his or her feet on the platform;

FIG. 12 is a schematic, end view of the first and second ladder assemblies with the cleats of each ladder assembly engaging the rail of the other ladder assembly;

FIG. 13 is a schematic, side view of the first and second ladder assemblies with the cleats of each ladder assembly engaging the rail of the other ladder assembly;

FIG. 14 is a schematic, side front view of the ladder system in a compact arrangement in which the cleats of the third ladder assembly are engaging the rails of the first and second ladder assemblies; and

FIG. 15 is a schematic, side view of the ladder system in the compact arrangement of FIG. 14.

### DESCRIPTION OF THE PREFERRED EMBODIMENTS

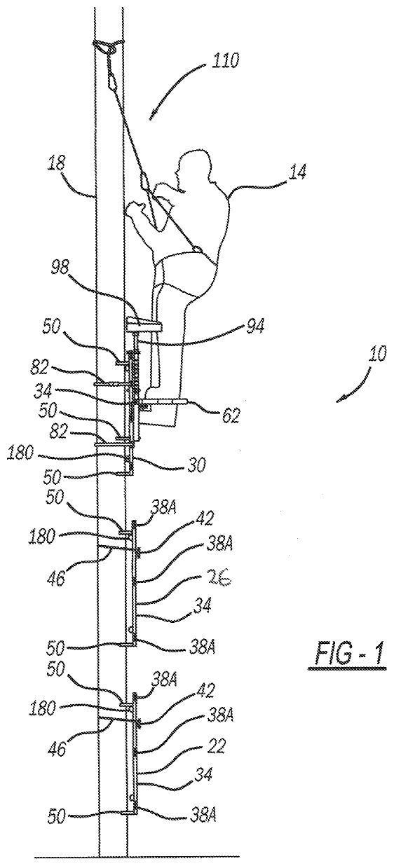

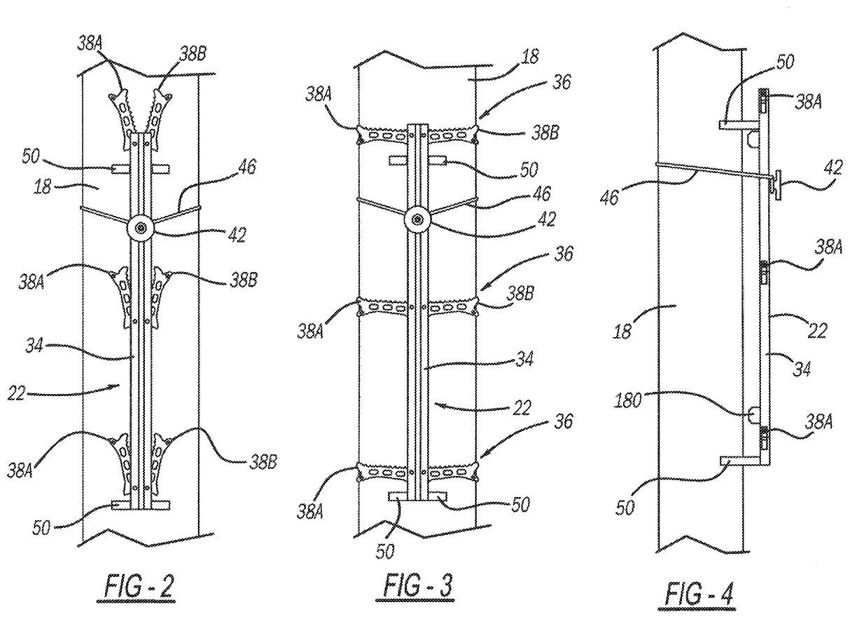

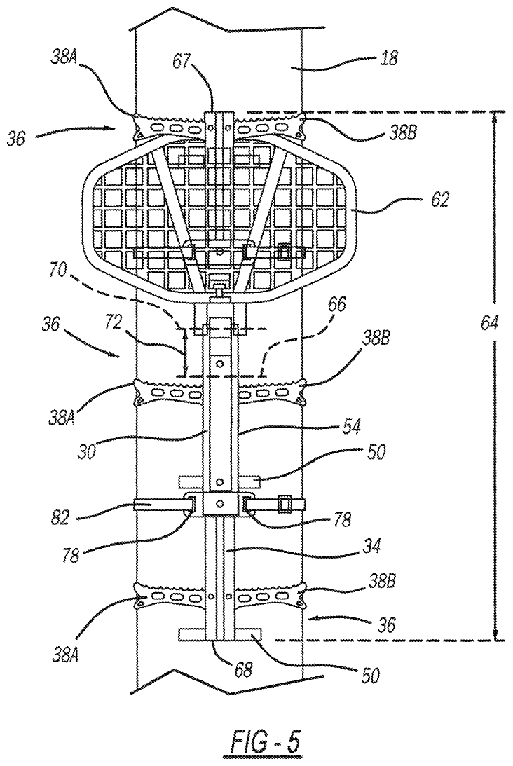

Referring to FIG. 1, a tree stand system 10 is schematically depicted. The system 10 enables a hunter 14 to climb to an elevated position in a tree 18, and supports the hunter 14 in the elevated position. The system 10 in the embodiment depicted includes three ladder assemblies 22, 26, 30. FIGS. 2-4, wherein like reference numbers refer to like components from FIG. 1, schematically depict ladder assembly 22. Ladder assemblies 22, 26 are substantially identical to one another.

Referring to FIGS. 1-4, ladder assembly 22 includes a frame rail 34. The ladder assembly 22 also includes a plurality of steps 36. Each step 36 has two step members 38A, 38B rotatably mounted to the rail 34. More specifically, each of the step members 38A is rotatable with respect to the rail 34 between a retracted position in which the step member 38A is generally parallel to the rail 34, as shown in FIG. 2, and an extended position in which the step member 38A is generally perpendicular to the rail 34 and extends to one side of the rail 34, as shown in FIG. 3.

Similarly, each of the step members 38B is rotatable with respect to the rail 34 between a retracted position in which the step member 38B is generally parallel to the rail 34, as shown in FIG. 2, and an extended position in which the step member 38B is generally perpendicular to the rail 34 and extends to another side of the rail 34, as shown in FIG. 3.

Each step member 38A is adjacent to a step member 38B so that, when the step members 38A, 38B are in their extended position, each step member 38A is aligned with a corresponding step member 38B to form a single step 36. One example of step members that may be employed within the scope of the claimed invention are disclosed in U.S. Pat. No. 8,556,035, issued Oct. 15, 2013, and which is hereby incorporated by reference in its entirety.

The ladder assembly 22 includes at least one fastening element 42 mounted with respect to the frame rail 34. The fastening element 42 is configured to secure a flexible member to the frame rail 34. In the embodiment depicted, the flexible member is a rope 46; however other flexible members such as a strap, cable, or chain may be employed within the scope of the claimed invention. In the embodiment depicted, the fastening element 42 is a versa button, as understood by those skilled in the art. The rope 46 secures the ladder assembly 22 to the tree 18, and is looped or tied around the fastening element 42.

The ladder assembly 22 further includes a plurality of cleats 50 mounted to the frame rail 34. In the embodiment depicted, the assembly 22 includes two cleats 50. The cleats 50 are configured to contact the tree 18 as shown. As noted, the ladder assembly 26 is substantially identical to the ladder assembly 22, and therefore includes the same elements and features.

FIGS. 5-7, wherein like reference numbers refer to like components from FIGS. 1-4, schematically depict ladder assembly 30. Referring to FIGS. 5-7, the ladder assembly 30 includes a frame rail 34 with steps 36 having step members 38A, 38B rotatably mounted thereto, in the same manner and locations as ladder assemblies 22, 26. Ladder assembly 30 also includes a support bracket 54 and a platform support system 58 mounted to the frame rail 34.

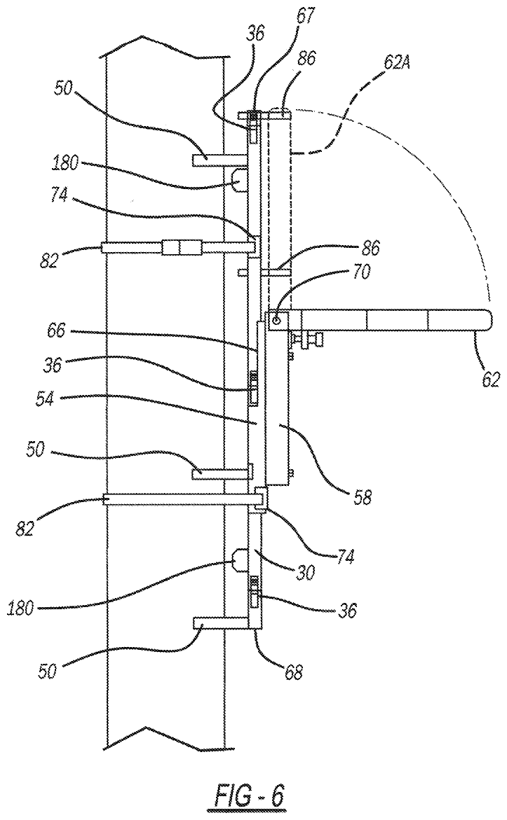

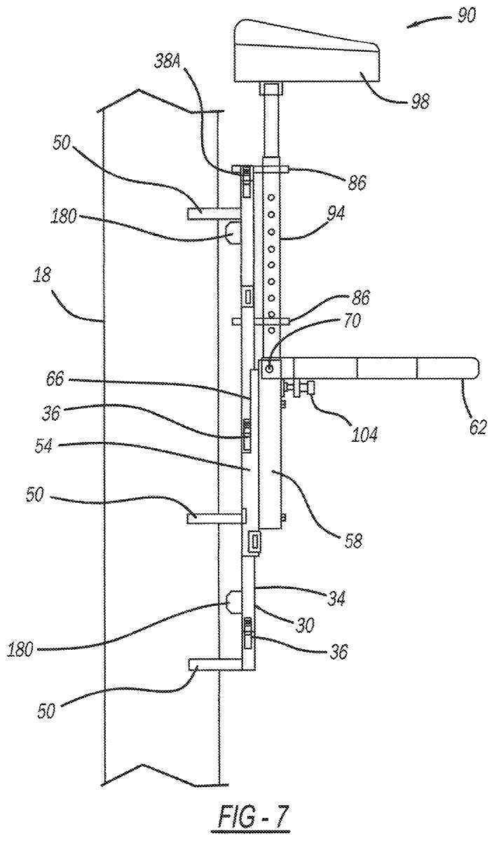

A foot platform 62 is pivotably connected to the rail 34 via the bracket 54 and support system 58, and is selectively pivotable with respect to the rail 34 between an extended position and a retracted, or stowed, position. In the retracted position, as shown in FIG. 5, the platform 62 is substantially parallel to the rail 34 and vertically oriented when the assembly 30 is in use. In the extended position, as shown in FIGS. 6 and 7, the platform 62 is generally perpendicular to the rail 34 and horizontally oriented when the assembly 30 is in use. In FIG. 6, the platform is shown in phantom at 62A in its retracted position.

As best shown in FIG. 5, the frame rail 34 is characterized by a length 64band a midpoint 66 located equidistant from the two ends 67, 68 of the rail 34. The platform 62 is characterized by a pivot axis 70 that is a distance 72 from the midpoint 66. The distance 72 between the pivot axis 70 and the midpoint 66 of the frame rail 34 is less than or equal to 25% of the rail's length 64 and, more preferably, the distance 72 between the pivot axis 70 and the midpoint 66 of the frame rail 34 is less than or equal to 10% of the rail's length 64. Accordingly, the pivot axis 70 of the platform, and the point at which the platform 62 is attached to the rail, is approximately halfway between the ends of the rail 34.

The steps 36 are mounted to the rail 34 such that two of the steps 36 are on one side of the pivot axis 70, and one of the steps 36 is on the other side of the pivot axis. Accordingly, when the ladder assembly 30 is attached to the tree 18, one of the steps 36 is above the pivot axis 70 and two of the steps 36 are below the pivot axis 70. The ladder assembly 30 also includes three cleats 50 mounted to the rail 34 and in contact with the tree 18 during use.

The cleats 50 are spaced apart along the length of the rail 34 such that two of the cleats 50 are on one side of the pivot axis 70, and one of the cleats 50 is on the other side of the pivot axis 70. Accordingly, when the ladder assembly 30 is attached to the tree 18, one of the cleats 50 is above the platform's pivot axis 70 and near the top end 67 of the rail 34, and two of the cleats 50 are below the pivot axis 70.

This arrangement of the platform 62, cleats 50, and steps 36 relative to the rail 34 and each other provides significant benefits over the prior art. More specifically, and without limitation, the location of the pivot axis 70 of the platform 62 relative to the rail 34 enables a user to safely and easily grasp and hold onto the step 36 positioned above the platform 62, which provides safer entry and exit off the platform 62. The position of the axis 70 also enhances stability of the assembly 30 relative to the tree 18, enhancing safety. Furthermore, the steps 36 below the platform 62 enable the user to take pressure and weight off the platform in order to move the platform to its retracted position for descending down the tree. Moreover, the placement of the platform 62 near the midpoint 66 results in a more compact assembly 30 because the platform 62 does not increase the length of the assembly 30 when the platform 62 is in the retracted position. The quantity and spacing of the cleats 50 enhances safety of the ladder assembly 30 by improving stability of the assembly 30 when in use.

The ladder assembly 30 also includes two brackets 74 mounted to the rail 34 and defining slots 78. The assembly 30 also includes two straps 82; each strap 82 is engaged with the slots 78 of a respective bracket 74, and secures the assembly 30 to the tree 18. Each bracket 74 and strap 82 forms a fastening element that connects the ladder assembly 30 to the tree 18. Each bracket 74 is on a respective side of the axis 70, i.e., the axis 70 is between the brackets 74, thereby enhancing stability of the ladder assembly 30 during use.

The ladder assembly 30 includes a plurality of brackets 86 mounted to the rail 34. Each bracket 86 defines a respective aperture. The brackets 86 are positioned such that the apertures are aligned. As shown in FIG. 7, a seat assembly 90 has a telescoping support pole 94 and a seat 98 connected to the pole 94. The pole 94 is insertable through the aligned apertures of brackets 86 to retain the seat assembly 90 with respect to the rail 34. The lower end of the pole 94 may rest on the platform 62 as shown. The two telescoping portions of the pole 94 are selectively movable with respect to each other to adjust the height of the seat 98 above the platform 62.

An adjustment screw 104 is mounted to the platform 62 and configured to contact another portion of the ladder assembly 30, such as the support system 58, when the platform 62 is in the extended position. Turning the adjustment screw 104 changes the angle between the platform 62 and the rail 34, which enables a user to make the platform horizontal if the tree 18, and therefore the rail 34, is not perfectly vertical.

Referring again to FIG. 1, a method of using the tree stand system 10 includes attaching the first ladder assembly 22 assembly to the tree 18; attaching the second ladder assembly 26 to the tree 18 above the first ladder assembly 22; attaching the third ladder assembly 30 to the tree above the second ladder assembly 26; and moving the platform 62 to the substantially horizontal, extended position after climbing the first and second ladder assemblies 22, 26 and at least part of the third ladder assembly 30. A harness system 110 is preferably worn by the hunter 14 and attached to the tree 18 as shown.

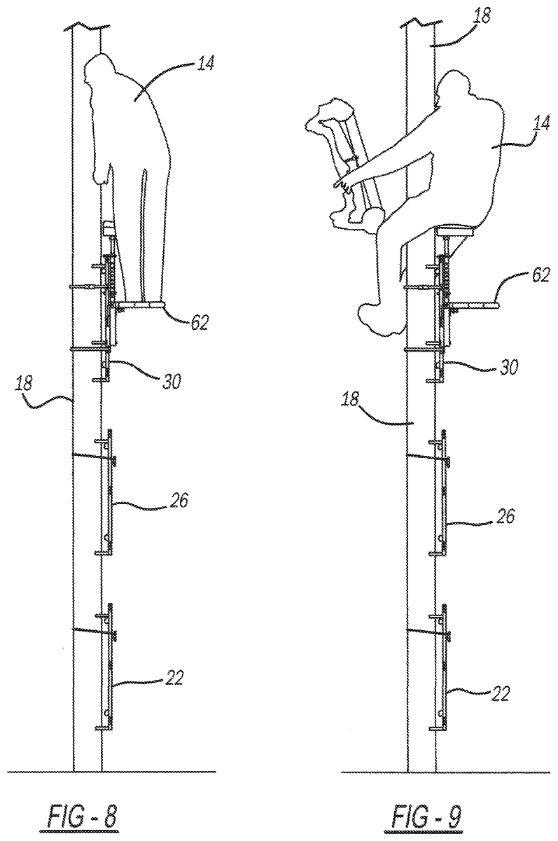

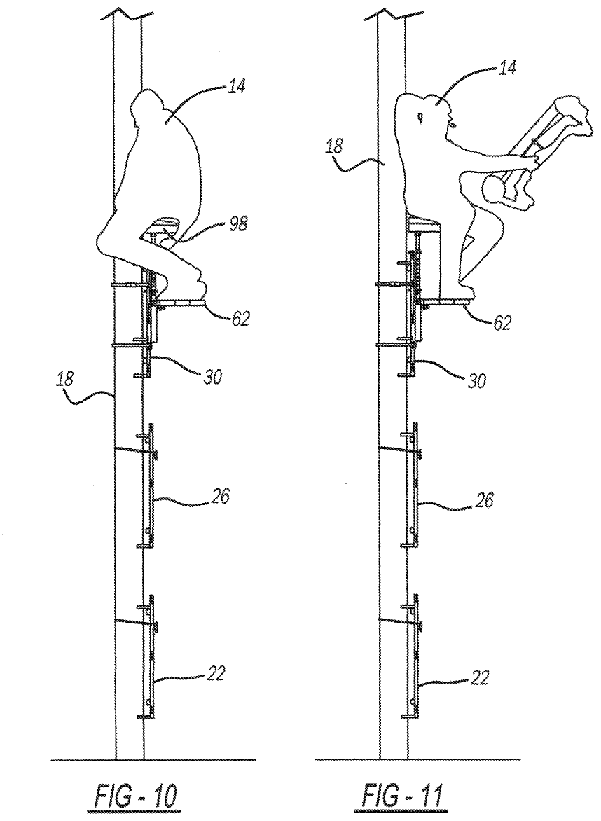

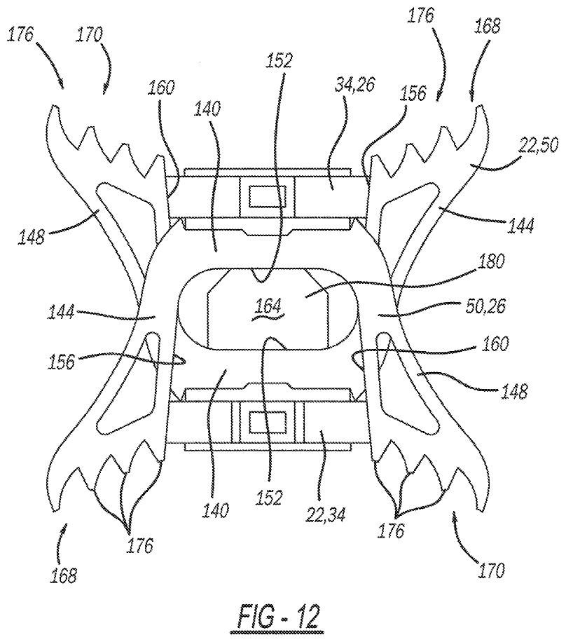

The system 10 enables the ladder assemblies 22, 26, 30 to be attached to the tree 18 in a substantially vertical and substantially linear arrangement relative to each other, thereby enabling the hunter 14 to reach the platform 62 and seat 98 without having to move substantially horizontally. The hunter 14 may then stand upon the platform 62, as shown in FIG. 8; sit upon the seat 98 facing the tree 18 (and positioning his or her legs such that the tree 18 is therebetween) as shown in FIG. 9; sit upon the seat 98 facing the tree 18, with his or her feet on the platform 62, as shown in FIG. 10; or sit on the seat 98 facing away from the tree 18 with feet resting on the platform 62, as shown in FIG. 11. Referring specifically to FIG. 1, one benefit of the system 10 is the ability of the hunter 14 to place one foot on the platform 62 and one foot on one of the steps 36 below the platform 62, which provides side pressure on the stand for moving around the tree 18 as needed.

The tree stand system 10 is configured to be packable to a very small volume for ease of transportation. FIGS. 12-15, wherein like reference numbers refer to like components from FIGS. 1-11, schematically depict a method of packing the tree stand system. Referring to FIG. 12, each cleat 50 is generally U-shaped. More specifically, each cleat 50 includes a first segment 140, a second segment 144, and a third segment 148. The first segment 140 is mounted to a rail 34. The second and third segments 144, 148 are spaced apart from each other and extend from the first segment 140.

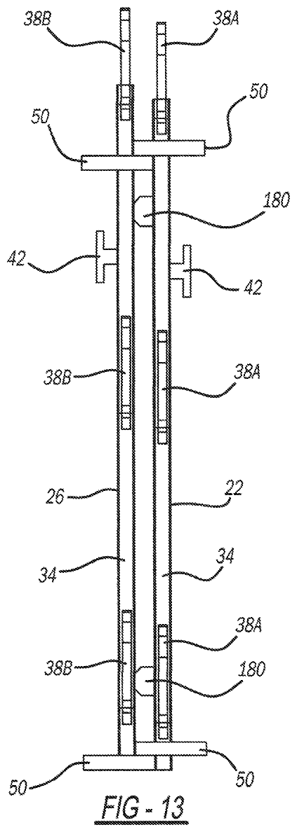

The first segment 140 defines a first surface 152; the second segment defines a second surface 156; and the third segment 148 defines a third surface 160. The second and third surfaces 156, 160 are spaced apart from, and parallel to, each other. The first surface 152 interconnects, and is perpendicular to, the second and third surfaces 156, 160. Accordingly, the first, second, and third surfaces 152, 156, 160 of segments 140, 144, 148, respectively, cooperate to define a cavity 164 in the cleat 50. The ends 168, 172 of each of segments 144, 148 define a plurality of teeth 176 for engagement with the tree. The opening to the cavity 164 is between the ends 168, 172 of the segments 144, 148. Each of the ladder assemblies 22, 26 includes an elastomeric bumper or grommet 180 mounted to the rail 34, as best shown in FIG. 13.

The width of the cavity 164 is marginally larger than the width of the rails 34; accordingly, the rails 34 are fittable inside the cavities 164. Referring to FIGS. 12 and 13, the method includes positioning the first ladder assembly 22 relative to the second ladder assembly 26 such that the rail 34 of the first ladder assembly 22 extends through the cavities 164 in each of the cleats 50 of the second ladder assembly 26, and so that the rail 34 of the second ladder assembly 26 extends through the cavities 164 in each of the cleats 50 of the first ladder assembly 22, as shown in FIGS. 12 and 13. The grommet 180 of the first ladder assembly 22 is positioned to contact the rail 34 of the second ladder assembly 26, and the grommet 180 of the second ladder assembly 26 is positioned to contact the rail 34 of the first ladder assembly 22, as shown in FIGS. 12 and 13.

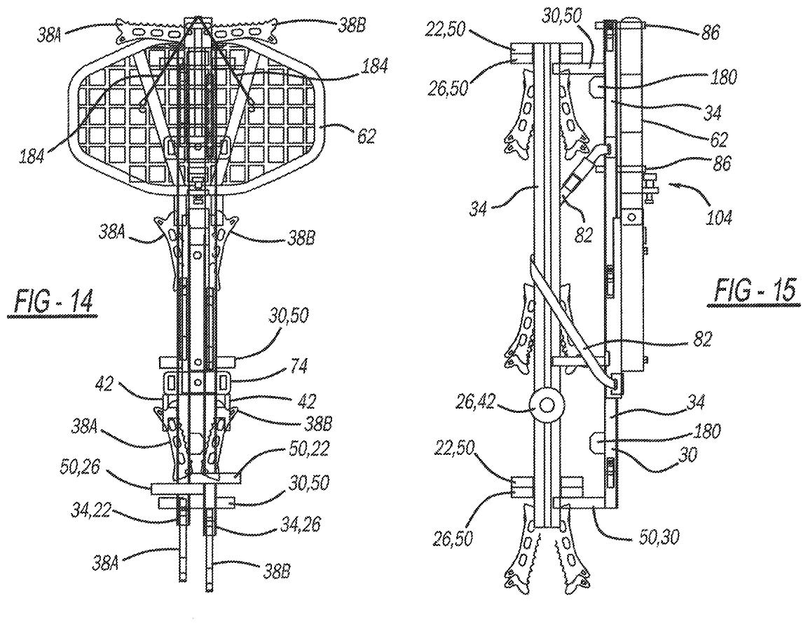

The method then includes pressing the rails 34 towards each other to slightly compress the grommets 180; with the grommets 180 compressed, the method includes positioning the rails 34 of the first and second ladder assemblies 22, 26 inside each of the cavities 164 in the cleats 50 of the third ladder assembly 30, as shown in FIGS. 14 and 15 until grommets 180 on the rail 34 of the third ladder assembly 30 contacts the rails 34 of the first and second ladder assemblies 22, 26. One or more of the straps 82 may then be wrapped around the first and second ladder assemblies 22, 26 and secured to the brackets 74 of the third ladder assembly tie all the assemblies 22, 26, 30 together. With the step members 38A, 38B in their retracted positions and the platform 62 in its retracted position, the system 10 is now extremely compact and easily carried by hand or on a hunter's back. The third ladder assembly 30 includes elastic cords 184 connected to the rail 34; the cords 184 are connectable to the platform 62 to maintain the platform 62 in its retracted position.

The method may also include removing the seat assembly 90 from the third ladder assembly 30. It should be noted that the seat assembly 90 is optional. The system 10 may be employed without a seat, especially when used with a harness system (also known as “saddle hunting,” as understood by those skilled in the art). It should be further noted that cables are not used to support the platform 62, thereby reducing the weight of the system 10 compared to the prior art.

While the best modes for carrying out the invention have been described in detail, those familiar with the art to which this invention relates will recognize various alternative designs and embodiments for practicing the invention within the scope of the appended claims.

1. An apparatus comprising:
a rail;
a plurality of steps mounted to the rail and extending perpendicular to the rail;
a plurality of cleats mounted to the rail and configured to engage a tree;
a platform being pivotably mounted with respect to the rail and selectively rotatable about an axis between a stowed position in which the platform is substantially parallel with the rail, and an extended position in which the platform is substantially perpendicular to the rail;
wherein said rail is characterized by a length and a midpoint along the length; and
wherein the axis is a distance from the midpoint; and
wherein the distance is less than or equal to 25% of the length.

2. The apparatus of claim 1, wherein the distance is less than or equal to 10% of the length.

3. The apparatus of claim 1, wherein said plurality of steps includes first, second, and third steps; and
wherein said first and second steps are on a first side of the axis and said third step is on a second side of the axis.

4. The apparatus of claim 1, wherein said plurality of cleats includes first, second, and third cleats;
wherein said first and second cleats are on a first side of the axis and said third cleat is on a second side of the axis.

5. The apparatus of claim 1, further comprising two fastening elements mounted to the rail and configured to attach the rail to a tree;
wherein said pivot axis is between the fastening elements.

6. The apparatus of claim 1, further comprising a plurality of brackets mounted with respect to the rail;
wherein each of said brackets defines a respective aperture; and
wherein the brackets are arranged such that the apertures are aligned with each other.

7. The apparatus of claim 6, further comprising a seat assembly having a telescoping support pole and a seat;
said telescoping support pole extending through said aligned apertures.

8. The apparatus of claim 7, further comprising an adjustment screw mounted to the platform and configured to contact another portion of the apparatus when the platform is in the extended position.

9. A method comprising:
attaching a first ladder assembly to a tree;
attaching a second ladder assembly to the tree above the first ladder assembly;
attaching a third ladder assembly to the tree above the second ladder assembly, said third ladder assembly having a platform that is pivotable between a generally vertical position and a substantially horizontal position; and
moving the platform to the substantially horizontal position.

10. The method of claim 9, further comprising climbing the first, second, and third ladder assemblies; and
wherein said moving the platform to the substantially horizontal position is performed after climbing at least part of the third ladder assembly.

11. The method of claim 10, wherein said third ladder assembly includes a seat above the platform; and
wherein the method further includes sitting on the seat.

12. The method of claim 11, wherein sitting on the seat includes sitting on the seat facing the tree and placing legs on opposite sides of the tree.

13. The method of claim 9, further comprising using two straps or ropes to attach the third ladder assembly to the tree.

14. The method of claim 9, further comprising using a harness to interconnect a hunter to the tree.

15. A tree stand system comprising:
a first ladder assembly;
a second ladder assembly; and
a third ladder assembly;
each of said ladder assemblies including a rail and cleats mounted to the rail;
wherein each of said cleats defines a respective cavity;
wherein said first, second and third ladder assemblies are configured such that the tree stand system is arrangeable in a compact configuration; and
wherein, when the tree stand system is in the compact configuration, the rail of the first ladder assembly extends into the cavities of the cleats of the second ladder assembly, the rail of the second ladder assembly extends into the cavities of the cleats of the first ladder assembly, and the rails of the first and second ladder assemblies extend through the cavities of the cleats of the third ladder assembly.

16. The tree stand system of claim 15, wherein the third ladder assembly includes a platform the is pivotably connected to the rail of the third ladder assembly.
